(19) United States
(12) Patent Application Publication
(10) Pub. No.: US 2025/0370754 A1
(43) Pub. Date: Dec. 4, 2025

(54) INSTRUCTION PROCESSING METHOD AND APPARATUS, DEVICE, STORAGE MEDIUM, CHIP, AND PROGRAM PRODUCT

(71) Applicant: Tencent Technology (Shenzhen) Company Limited, Shenzhen (CN)

(72) Inventors: Hua TIAN, Shenzhen (CN); Ran XIAO, Shenzhen (CN); Kai YAN, Shenzhen (CN); Ronglin JIANG, Shenzhen (CN)

(73) Assignee: Tencent Technology (Shenzhen) Company Limited, Shenzhen, GD (CN)

(21) Appl. No.: 19/299,834

(22) Filed: Aug. 14, 2025

Related U.S. Application Data
(63) Continuation of application No. PCT/CN2024/107176, filed on Jul. 24, 2024.

(30) Foreign Application Priority Data
Aug. 18, 2023 (CN) 202311045064.9

(51) Int. Cl. G06F 9/38; G06F 9/32

(52) U.S. Cl. CPC G06F 9/3838; G06F 9/325

(57) ABSTRACT

An instruction processing method and apparatus, a device, a storage medium, a chip, and a program product. The method includes: acquiring an instruction sequence, and constructing a relationship graph of the instruction sequence, the instruction sequence including a plurality of instructions for loop execution; determining a loop interval based on the relationship graph, the loop interval being configured for representing a maximum time interval within which the same instruction is scheduled in two adjacent loop iterations; gradually reducing the loop interval, and determining a previous loop interval as a target loop interval when the plurality of instructions are not capable of being scheduled successfully for the first time within a current loop interval; and adjusting a scheduling time sequence of the plurality of instructions in parallel loop iterations based on the target loop interval, and loading the adjusted instructions onto a chip for running.

### RELATED APPLICATION

This application is a continuation application of PCT Patent Application No. PCT/CN2024/107176, filed on Jul. 24, 2024, which claims priority to Chinese Patent Application No. 202311045064.9, filed with the China National Intellectual Property Administration on Aug. 18, 2023, each of which is incorporated by reference in its entirety.

### FIELD OF THE TECHNOLOGY

This application relates to the technical field of chips and semiconductors, and in particular, to an instruction processing method and apparatus, a device, a storage medium, a chip, and a program product.

### BACKGROUND OF THE DISCLOSURE

In recent years, artificial intelligence (AI) has developed rapidly. More and more people strive to research and develop related AI infrastructures. For example, during code generation at an AI compiler backend, main AI chip execution time is consumed by a large number of loop instruction structures present in a basic computing unit of AI. How to improve code generation efficiency of the AI chip is a research focus in the field.

In the related technology, a loop interval for loop execution of a plurality of instructions is obtained by testing loop intervals one by one from the lower bound in ascending order. However, this approach relies on trial-and-error through scheduling failures, and has time consumption typically 100 to 1000 times that of a successful scheduling attempt. As a result, a significant amount of time is required to determine a target loop interval, which adversely affects efficiency of subsequent code generation.

### SUMMARY

Embodiments of this embodiment provide an instruction processing method and apparatus, a device, a storage medium (e.g., a non-transitory storage medium), a chip, and a program product, to improve efficiency of acquiring a target loop interval. The technical solutions are as follows:

In an aspect, the embodiments of this disclosure provide an instruction processing method, which includes:
acquiring an instruction sequence, and constructing a relationship graph of the instruction sequence, the instruction sequence including a plurality of instructions for loop execution, nodes in the relationship graph being configured for representing the instructions in the instruction sequence, and an edge connecting two nodes in the relationship graph being configured for representing a dependency relationship between two instructions corresponding to the two nodes;
determining a loop interval based on the relationship graph, the loop interval being configured for representing a maximum time interval within which the same instruction is scheduled in two adjacent loop iterations;
gradually reducing the loop interval, and determining a previous loop interval as a target loop interval when the plurality of instructions are not capable of being scheduled successfully for the first time within a current loop interval; and
adjusting a scheduling time sequence of the plurality of instructions in parallel loop iterations based on the target loop interval, and loading the adjusted instructions onto a chip for running.

In another aspect, the embodiments of this disclosure provide an instruction processing apparatus, which includes:
a first construction module, configured to acquire an instruction sequence, and construct a relationship graph of the instruction sequence, the instruction sequence including a plurality of instructions for loop execution, nodes in the relationship graph being configured for representing the instructions in the instruction sequence, and an edge connecting two nodes in the relationship graph being configured for representing a dependency relationship between two instructions corresponding to the two nodes;
a determination module, configured to determine a loop interval based on the relationship graph, the loop interval being configured for representing a maximum time interval within which the same instruction is scheduled in two adjacent loop iterations;
a processing module, configured to gradually reduce the loop interval, and determine a previous loop interval as a target loop interval when the plurality of instructions are not capable of being scheduled successfully for the first time within a current loop interval; and
an adjustment module, configured to adjust a scheduling time sequence of the plurality of instructions in parallel loop iterations based on the target loop interval, and load the adjusted instructions onto a chip for running.

In another aspect, the embodiments of this disclosure provide a computer device, which includes a processor and a memory. The memory is configured to store at least one computer program, and the processor loads and executes the at least one computer program to implement the instruction processing method according to the embodiments of this disclosure.

In another aspect, the embodiments of this disclosure provide a computer-readable storage medium, which has at least one computer program stored therein. A processor loads and executes the at least one computer program to implement the instruction processing method according to the embodiments of this disclosure.

In another aspect, the embodiments of this disclosure provide a chip, which includes a programmable logic circuit and/or program instructions. When run on a computer device, the chip is configured to implement the instruction processing method according to the embodiments of this disclosure.

In another aspect, the embodiments of this disclosure provide a computer program product, which includes a computer program. The computer program is stored in a computer-readable storage medium, and a processor of a computer device reads the computer program from the computer-readable storage medium and executes the computer program, to cause the computer device to perform the instruction processing method according to the embodiments of this disclosure.

### BRIEF DESCRIPTION OF THE DRAWINGS

To describe the technical solutions in the embodiments of this disclosure more clearly, the following briefly introduces the accompanying drawings required for describing the embodiments. Apparently, the accompanying drawings in the following description show only some embodiments of this disclosure, and a person of ordinary skill in the art may still derive other drawings from these accompanying drawings without creative efforts.

FIG. 1 is a schematic diagram of an implementation environment of an instruction processing method according to an embodiment of this application.

FIG. 2 is a flowchart of an instruction processing method according to an embodiment of this application.

FIG. 3 is a schematic diagram of a modulo scheduling algorithm according to an embodiment of this application.

FIG. 4 is a flowchart of another instruction processing method according to an embodiment of this application.

FIG. 5 is a schematic diagram of a relationship graph according to an embodiment of this application.

FIG. 6 is a diagram of a first instruction processing process according to an embodiment of this application.

FIG. 7 is a flowchart of a loop interval calculation process according to an embodiment of this application.

FIG. 8 is a flowchart of modulo scheduling according to an embodiment of this application.

FIG. 9 is a diagram of a system architecture according to an embodiment of this application.

FIG. 10 is a block diagram of an instruction processing apparatus according to an embodiment of this application.

FIG. 11 is a block diagram of another instruction processing apparatus according to an embodiment of this application.

FIG. 12 is a structural block diagram of a terminal according to an embodiment of this application.

FIG. 13 is a schematic structural diagram of a server according to an embodiment of this application.

### DESCRIPTION OF EMBODIMENTS

To make the objectives, technical solutions, and advantages of this application clearer, the following further describes implementations of this application in detail with reference to the accompanying drawings.

In this application, the terms “first”, “second”, and the like are used for distinguishing between same items or similar items of which effects and functions are basically the same. The “first”, “second”, and “nth” do not have a dependency relationship in logic or time sequence, and a quantity and an execution order thereof are not limited.

In this application, the term “at least one” means one or more, and “a plurality of” means two or more.

In addition, information (including but not limited to, user device information, user personal information, and the like), data (including but not limited to, data for analysis, stored data, displayed data, and the like), and signals involved in this application are all authorized by a user or fully authorized by each party, and collection, use, and processing of relevant data need to comply with relevant laws and regulations and standards of relevant countries and regions. For example, an instruction sequence involved in this application is acquired with full authorization.

For ease of understanding, terms involved in embodiments of this disclosure are described below.

Operator: it is a basic computing unit of a machine learning (ML) model.

Compiler: it refers to a translation program that can translate a source program written in a high-level programming language into an equivalent target program in a low-level programming language (for example, following a machine language format).

Directed acyclic graph (DAG): if a directed graph starts from any node and cannot return to the node through several edges, the graph is a DAG. In the embodiments of this disclosure, a DAG is configured for representing a dependency relationship between instructions. For example, if data generated by an instruction A is transmitted to an instruction B through a register, a directed edge pointing from a node A to a node B is shown in a DAG, and a weight is minimum waiting duration from a moment when the instruction A is issued to a moment when the data is transmitted to the instruction B.

Initiation interval (II): it is a time difference between moments when an instruction is executed in two loops during modulo scheduling. It is also referred to as a loop interval in the embodiments of this disclosure.

Objective initiation interval (ObjII): it is a minimum II within which all instructions participating in a loop can be scheduled successfully, and is a search target of an II search algorithm.

Heuristic algorithm: in contrast to an optimization algorithm, the heuristic algorithm does not solve an optimization problem mathematically. It is an algorithm constructed based on intuition or experience, and is widely applied to the field of compilers.

An instruction processing method provided in the embodiments of this disclosure can be performed by a computer device. In some embodiments, the computer device is a terminal or a server. The following first describes an implementation environment of the instruction processing method provided in the embodiments of this disclosure by using an example in which the computer device is a server. FIG. 1 is a schematic diagram of an implementation environment of an instruction processing method according to an embodiment of this application. Refer to FIG. 1. The implementation environment includes a terminal 101 and a server 102. The terminal 101 and the server 102 can be connected directly or indirectly by using a wired or wireless communication protocol. This is not limited in this application.

In some embodiments, the terminal 101 includes, but is not limited to, a smartphone, a tablet computer, a notebook computer, a desktop computer, a smart speaker, a smart watch, a smart voice interactive device, a smart household appliance, an on-board terminal, or the like. An artificial intelligence (AI) chip is installed on the terminal 101. Instructions in the AI chip may be compiled by an AI compiler in the server 102. A specification of the AI chip is not limited in the embodiments of this disclosure.

Exemplarily, the terminal 101 is a user terminal.

Correspondingly, after the server 102 compiles a source program of an ML model through the AI compiler, and adjusts the source program by using the instruction processing method provided in the embodiments of this disclosure, the terminal 101 may acquire adjusted instructions from the server 102, and load the instructions onto the AI chip. In this way, ML may be subsequently implemented through the AI chip.

More or fewer terminals may be provided. For example, only one terminal is provided, or dozens or hundreds of terminals are provided, or more terminals are provided. The number of terminals and the device type are not limited in the embodiments of this disclosure.

In some embodiments, the server 102 is an independent physical server, or a server cluster or distributed system including a plurality of physical servers, or a cloud server providing basic cloud computing services such as a cloud service, a cloud database, cloud computing, a cloud function, cloud storage, a network service, cloud communication, a middleware service, a domain name service, a security service, a content delivery network (CDN), and a big data and AI platform.

The AI compiler is run on the server 102. The server 102 may acquire the source program of the ML model. Then, the server 102 compiles the source program of the ML model through the AI compiler, and adjusts the source program by using the instruction processing method provided in the embodiments of this disclosure, to obtain instructions that can be understood and executed quickly by the AI chip. Then, the server 102 may load the instructions onto the AI chip of the terminal 101.

In a compiling process, for a plurality of instructions participating in a loop, the server 102 may calculate a target loop interval of the plurality of instructions participating in the loop by using the instruction processing method provided in the embodiments of this disclosure, and adjusts a structure of the plurality of instructions participating in the loop based on the target loop interval, to obtain a target program that can be finally quickly run on the AI chip. Then, the server 102 may load the target program onto the AI chip of the terminal 101.

In some embodiments, the server 102 is responsible for primary computing work, and the terminal 101 is responsible for secondary computing work. Alternatively, the server 102 is responsible for secondary computing work, and the terminal 101 is responsible for primary computing work. Alternatively, the server 102 and the terminal 101 perform collaborative computing based on a distributed computing architecture.

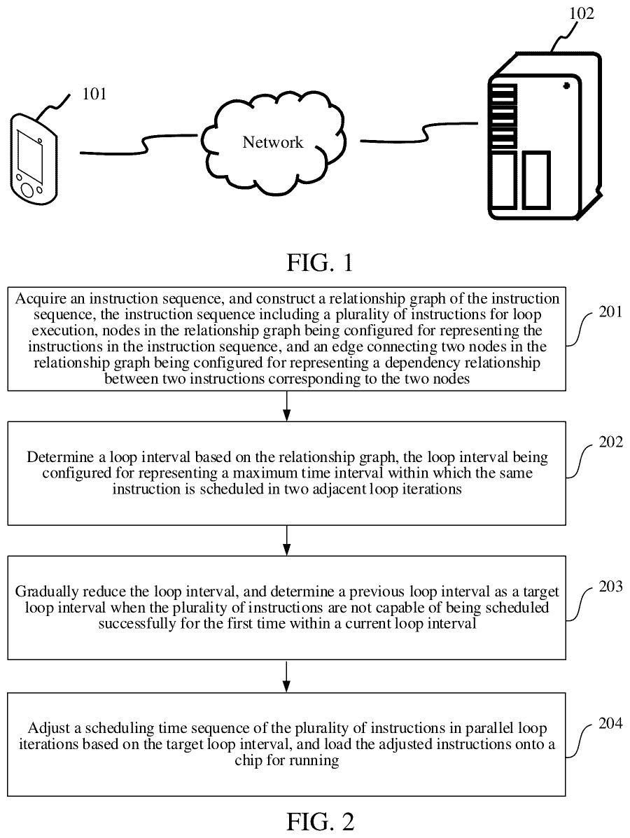

FIG. 2 is a flowchart of an instruction processing method according to an embodiment of this application. The method is performed by a computer device, for example, is performed by the server 102 in FIG. 1. The instruction processing method includes the following operations:

201: Acquire an instruction sequence, and construct a relationship graph of the instruction sequence, the instruction sequence including a plurality of instructions for loop execution, nodes in the relationship graph being configured for representing the instructions in the instruction sequence, and an edge connecting two nodes in the relationship graph being configured for representing a dependency relationship between two instructions corresponding to the two nodes.

In the embodiments of this disclosure, the instruction sequence includes a plurality of instructions. The plurality of instructions may be executed in a loop, which has two meanings:
1) the plurality of instructions is repeatedly executed as a whole in a serial manner or a parallel manner; and
2) in a single loop iteration, the plurality of instructions may be sequentially executed, and the execution order follows the program-specified sequence obtained during instruction fetch.

A specific manner for acquiring an instruction sequence may be as follows: a server may analyze an ML model to obtain an instruction sequence. Alternatively, the server may analyze another external source program, to obtain an instruction sequence. In an analysis process, the server sequentially obtains instructions according to preset analysis logic, and sorts the plurality of instructions according to the instruction fetch order, to obtain a final instruction sequence.

Then, the server constructs the nodes in the relationship graph based on the instructions in the instruction sequence. The server constructs the edges in the relationship graph based on the dependency relationship among the plurality of instructions. The relationship graph may be a DAG. This is not limited in the embodiments of this disclosure.

202: Determine a loop interval based on the relationship graph, the loop interval being configured for representing a maximum time interval within which the same instruction is scheduled in two adjacent loop iterations.

In the embodiments of this disclosure, the server may perform a next loop iteration after completing one loop iteration. In this case, the maximum time interval within which the same instruction is scheduled in two adjacent loop iterations is time consumed by a single loop iteration. The loop interval is also equivalent to duration required for sequentially scheduling the plurality of instructions in the single loop iteration.

In another embodiment of this application, the server may fold a loop process. Correspondingly, the two adjacent loop iterations have an overlapping part. That is, a next loop iteration may be performed before a previous loop iteration is completed. The folded loop process includes a target phase. In the target phase, all instructions for completing one loop iteration may be executed in parallel in a plurality of loop iterations. That is, in the target phase, the server may schedule all instructions participating in the loop. The process is a principle of a modulo scheduling algorithm. The instruction processing method provided in this application may be applied to a modulus scheduling algorithm, to determine minimum during required for executing the target phase.

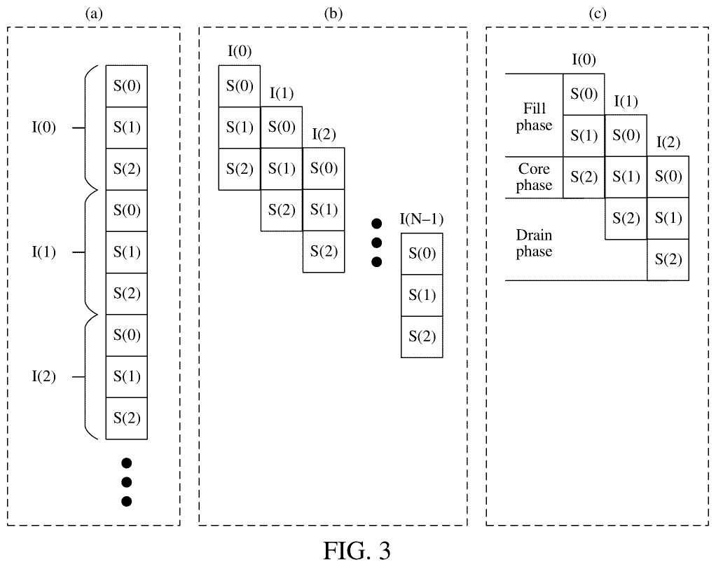

For example, FIG. 3 is a schematic diagram of a modulo scheduling algorithm according to an embodiment of this application. Refer to FIG. 3. It is assumed that a total number of loop iterations in a loop process is N. Time consumption of the instruction sequence participating in the loop in each loop iteration is T ticks. The “tick” refers to a timing unit of a timer in the server.

The plurality of instructions in the instruction sequence may be equally divided into three parts. Refer to (a) in FIG. 3. Each loop iteration is executed after a previous loop iteration is completed. A single loop iteration may be denoted as I (n), where n∈[0, 1, 2, . . . , N-2, N-1]. For any loop iteration, the plurality of instructions are equally divided into three parts, and each part may be denoted as S(i), where i∈[0, 1, 2].

Refer to (b) in FIG. 3 for a folded loop process. An I(n+1)^{th} loop iteration may be executed before an I(n)^{th} loop iteration is completed. A time difference between a start moment of the I(n)^{th} loop iteration and a start moment of the I(n+1)^{th} loop iteration is referred to as a loop interval or an II. The loop interval herein is equal to a number of occupied ticks (or duration) of some instructions in one loop iteration, and a loop interval in (b) is equal to T/3.

By analyzing the folded loop, it may be found that a stable instruction structure exists. Refer to (c) in FIG. 3. The loop includes three phases:
1) a fill phase, including instructions S(1) and S(0) at the beginning of the first two loop iterations;
2) a target phase, namely, a core phase, including instructions S(2), S(1), and S(0) in three consecutive loop iterations, these instructions forming all instructions for completing one loop iteration; and
3) a drain phase, including instructions S(2) and S(1) at the end of the last two loop iterations.

For one specific instruction in the loop, it is assumed that in a particular loop iteration, the instruction is issued at a kth tick relative to the first instruction in the loop iteration, in the target phase of the folded loop process, the instruction is issued at a moment T=K Mod II. II represents a loop interval. For example, before folding, if an instruction A is issued at a 16^{th} tick relative to the first instruction in a current loop iteration, and II is 10 ticks, after folding, the instruction A is issued at a 6^{th} tick in the target phase. Loop execution time of the target phase is also compressed to 10 ticks.

In the embodiments of this disclosure, the server determines a minimum loop interval within which all the instructions can be scheduled successfully, which may also be referred to as an ObjII. Then, the instructions in the target phase are executed within the minimum loop interval by a modulo extraction method.

Correspondingly, the server may determine, based on the dependency relationship among the plurality of instructions in the relationship graph, duration required for sequentially scheduling the plurality of instructions in a single loop iteration, namely, time consumption of the single loop iteration. The server takes the time consumption of the single loop iteration as the loop interval, namely, a maximum time interval within which the same instruction is scheduled in two adjacent loop iterations, which ensures that all instructions participating in the loop can be scheduled successfully within the loop interval. Then, in subsequent operation 203, the server can search, based on the maximum time interval, for a minimum loop interval within which all the instructions can be scheduled successfully.

203: Gradually, or progressively reduce the loop interval, and determine a previous loop interval as a target loop interval when the plurality of instructions are not able to be scheduled successfully for the first time within a current loop interval (or within a current loop). That is, upon failing to successfully schedule the plurality of instructions within the current loop for the first time.

In some implementations, in this operation, the server may update the loop interval by using a gradient descent method. When the plurality of instructions are not scheduled successfully within an updated current loop interval, the server takes a previous loop interval as the target loop interval. The target loop interval represents a minimum time interval (or minimum duration) within which the plurality of instructions can be scheduled successfully. In this disclosure, assuming the current loop is loop n, then the previous loop may be loop (n−i), where n and i are integers. Exemplarily, i=1.

In the embodiments of this disclosure, the server may gradually or progressively reduce the loop interval by using the gradient descent method. That is, the server may subtract a gradient from the loop interval each time, to update the loop interval. The gradient refers to unit duration. The unit duration may be 1 tick, 2 ticks, or the like. The unit duration is not limited in the embodiments of this disclosure.

Then, the server schedules the plurality of instructions in the instruction sequence within the updated current loop interval. When the plurality of instructions are scheduled successfully, the server reduces the current loop interval, and continues to perform scheduling based on the reduced loop interval. When the plurality of instructions cannot be scheduled successfully for the first time within the current loop interval, the server takes the previous loop interval as the target loop interval.

204: Adjust a scheduling time sequence of the plurality of instructions in parallel loop iterations based on the target loop interval, and load the adjusted instructions onto a chip for running/execution.

In the embodiments of this disclosure, the scheduling time sequence of the plurality of instructions in the parallel loop iterations form a structure of the instructions. Specifically, the parallel loop iterations refer to a plurality of loop iterations in which some instructions may be executed in parallel. The plurality of instructions are divided into the plurality of parallel loop iterations. In this way, the entire structure of the instructions includes a plurality of execution phases, such as the fill phase, the target phase, and the drain phase shown in (c) in FIG. 3. Each execution phase includes a scheduling time sequence of the instructions in each loop iteration. To-be-processed instructions in the target phase include the plurality of instructions, and duration of processing the instructions in the target phase is the target loop interval.

For example, in an AI chip, a basic computing unit includes a large number of loop instruction structures. Therefore, the adjusted instructions are loaded onto the basic computing unit in the AI chip, which enhances an instruction processing capability of the basic computing unit, and reduces duration required for running the loop instructions. Subsequently, ML or another function may be implemented quickly through the AI chip.

The embodiments of this disclosure provide the instruction processing method. The relationship graph is constructed based on the instruction sequence that includes the plurality of instructions participating in the loop, whereby the dependency relationship among the plurality of instructions participating in the loop can be determined clearly. Then, according to the dependency relationship among the plurality of instructions in the relationship graph, the duration required for sequentially scheduling the plurality of instructions in the single loop iteration, namely, the loop interval, is calculated, and the loop interval is taken as the maximum time interval between two adjacent loop iterations, which ensures that all the instructions participating in the loop can be scheduled successfully within the loop interval (the maximum time interval). Then, the loop interval is gradually reduced, and all the instructions participating in the loop are scheduled based on each reduced loop interval. When a scheduling failure occurs within a current loop interval, a previous loop interval is taken as the target loop interval, to ensure that all the instructions participating in the loop can be scheduled successfully within the target loop interval. In this way, a minimum loop interval can be found by gradually searching downward from a maximum loop interval within which successful scheduling can be ensured. Because time consumption of successful scheduling of the instructions is typically low, the foregoing method can improve efficiency of acquiring the target loop interval, which is beneficial to subsequent rapid adjustment of the structure of the plurality of instructions in a plurality of loop iterations according to the target loop interval. In this way, the instructions subjected to structure adjustment can be executed quickly, that is, a loop progress can be accelerated, and an instruction processing speed can be improved.

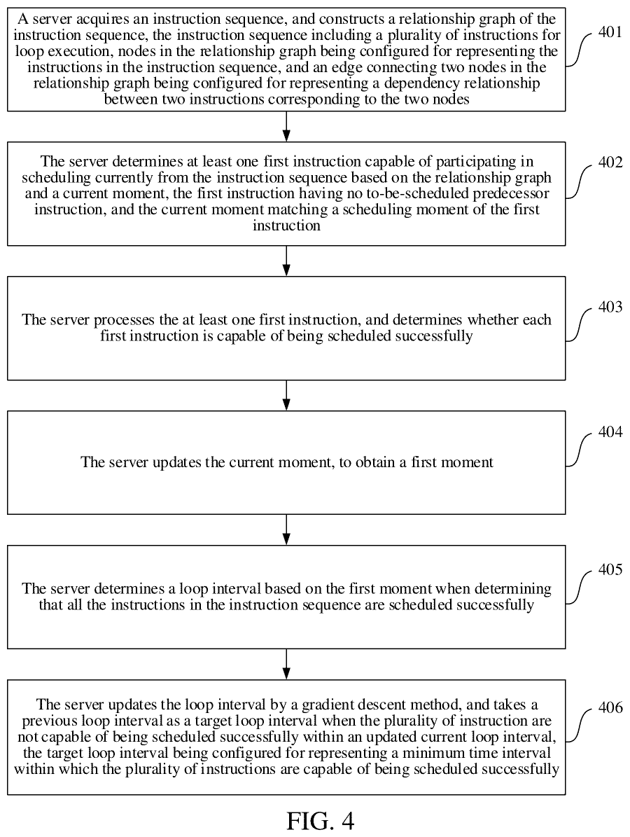

FIG. 4 is a flowchart of another instruction processing method according to an embodiment of this application. Refer to FIG. 4. In the embodiments of this disclosure, a description is made by using an example in which the method is performed by a server. The instruction processing method includes the following operations:

401: A server acquires an instruction sequence, and constructs a relationship graph of the instruction sequence, the instruction sequence including a plurality of instructions for loop execution, nodes in the relationship graph being configured for representing the instructions in the instruction sequence, and an edge connecting two nodes in the relationship graph being configured for representing a dependency relationship between two instructions corresponding to the two nodes.

In the embodiments of this disclosure, the server acquires the instruction sequence. A source of the instruction sequence is not limited in the embodiments of this disclosure. Then, the server respectively constructs a plurality of nodes according to the plurality of instructions in the instruction sequence. Then, the server constructs edges between the nodes according to the dependency relationship among the plurality of instructions. The plurality of nodes and the edges between every two nodes form the relationship graph. The relationship graph can reflect the dependency relationship among the plurality of instructions in the instruction sequence. The relationship graph may be a DAG. The dependency relationship may be a data dependency relationship or a memory dependency relationship. The data dependency relationship may refer to a data transmission relationship between two instructions. The memory dependency relationship may refer to a relationship between memory resources occupied by two instructions. This is not limited in the embodiments of this disclosure.

For the data dependency relationship, for example, data generated by an instruction A is transmitted to an instruction B through a register; and the instruction B can only be executed successfully based on the data generated by the instruction A, which indicates that the instruction B depends on the instruction A, that is, a dependency relationship exists between the instruction B and the instruction A. The server may construct a directed edge pointing from a node A (corresponding to the instruction A) to a node B (corresponding to the instruction B). A weight of the edge is minimum waiting duration from a moment when the instruction A is executed to a moment when the data is transmitted to the instruction B.

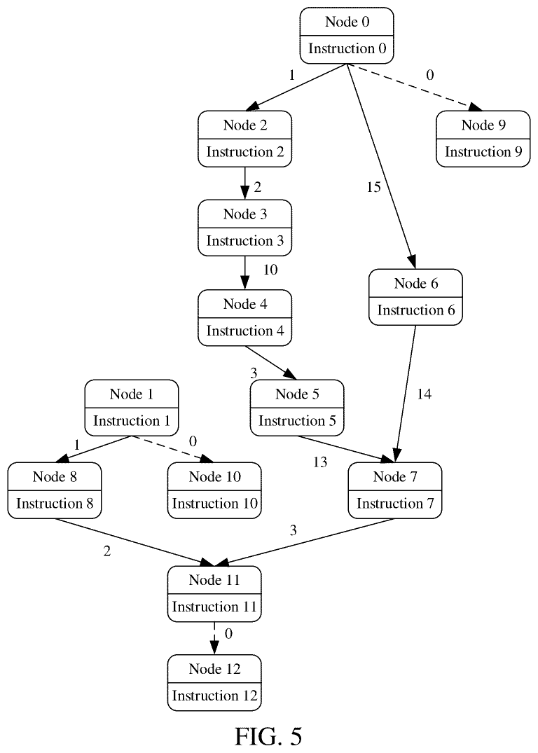

For example, FIG. 5 is a schematic diagram of a relationship graph according to an embodiment of this application. Refer to FIG. 5. The instructions in the instruction sequence are converted into nodes according to a time sequence of the instructions. A serial number of the node indicates a position of the instruction in the time sequence. The sequence may alternatively be considered as an order in which the instructions are sequentially inputted. A directed edge is added between every two instructions that have a data dependency relationship, and a weight of the directed edge represents a number of delay ticks of data transmission. The relationship graph includes 13 nodes, namely, a node 0 to a node 12. Correspondingly, the instruction sequence includes 13 instructions participating in a loop.

For any instruction, the instruction may include an instruction name, an input register name, and an output register name. The instruction name may be represented by an uppercase string, such as MIN (for minimum operation). The register name may be represented by a character “$” plus a lowercase string and a number. For example, $r8 represents a register 8. The constant is directly represented by a number. An instruction for outputting data to a register is formed by linking the output register name to the instruction name via “=”. The input register name and the constant follow the instruction name, and are separated via “,”. For example, an instruction “$r7=MIN $r8, $r6” means that a minimum value is obtained from an output of a register 8 and an output of a register 6, and the minimum value is taken as input data and is inputted into a register 7 for output. An instruction “$vr0=VLD $r10, 0” means that “0” is taken as input data and loaded into a register 10, and obtained output data is inputted into a register 0.

A weight of the edge in the relationship graph refers to waiting duration from a moment when an instruction at a starting point of the edge is executed to a moment when data generated by the instruction is transmitted to an instruction at an end point of the edge. That is, the weight of the edge is a time difference between moments when the two instructions represented by two nodes connected via the edge are executed.

In a process of executing the plurality of instructions in a single loop iteration, the server may statistically collect, through the timer, a time difference between two instructions that have a dependency relationship. Each time difference is waiting duration from a moment when one instruction is executed to a moment when the other instruction is executed, that is, a weight of an edge between nodes corresponding to the two instructions.

Then, the server may determine a scheduling moment of each node based on the weight of the edge. For an instruction, the so-called scheduling moment refers to relative time when the instruction is executed relative to initiation of execution of the first instruction. For example, a weight of a directed edge between a node 0 and a node 2 is 1, which indicates that an instruction corresponding to the node 2 can only be executed at least one tick after an instruction corresponding to the node 0 is executed.

The relationship graph may further record at least one type of information such as a height or a depth of the node. This is not limited in the embodiments of this disclosure.

The height of the node refers to a sum of weights of edges in a maximum path from the node to a node having no successor node (whose height is 0). The node having no successor node refers to a node having no child node.

The server may determine the height of the node according to the weights of the edges in the path from the node to the node having no successor node. For example, a maximum path from a node 0 to a node having no successor node is “node 0-node 2-node 3-node 4-node 5-node 7-node 11-node 12”, and correspondingly, a height of the node 0 is 1+2+10+3+13+3+0=32.

The depth of the node refers to a sum of weights of edges in a path from a root node (a node 0 ) to the node. For example, a depth of the node 0 is 0, and a depth of a node 3 is 1+2=3.

In addition, a solid edge in FIG. 5 indicates that in a current loop iteration, data is transmitted from a source node (a node 0 or a node 1 ) to a target node; and a dashed edge indicates that data of the target node is generated in the current loop iteration, and may be read by the source node in a next loop iteration.

402: The server determines at least one first instruction capable of participating in scheduling (or eligible to be scheduled) currently from the instruction sequence based on the relationship graph and a current moment, the first instruction having no to-be-scheduled predecessor instruction, and the current moment matching a scheduling moment of the first instruction.

In the embodiments of this disclosure, the first instruction refers to an instruction that can be scheduled at the current moment. The first instruction screened by the server from the instruction sequence satisfies the following two conditions:

one condition is that the instruction has no to-be-scheduled predecessor instruction, including that: the instruction has no predecessor instruction, or all predecessor instructions of the instruction have been scheduled successfully; and the other condition is that the current moment matches the scheduling moment of the instruction.

The scheduling moment of the instruction refers to time relative to time when the current loop iteration starts (the first instruction is executed).

In the relationship graph, the predecessor instruction refers to an instruction executed before the first instruction. Because the instructions are sequentially executed, the predecessor instruction may be a previous instruction adjacent to the first instruction, and whether the instruction has been scheduled is determined.

The server may first determine at least one second instruction having no to-be-scheduled predecessor instruction from the instruction sequence based on the relationship graph. The second instruction represents an instruction that can be scheduled in a case that the instruction satisfies a dependency relationship.

The second instruction may be an instruction having no predecessor instruction. For example, an instruction 0 and an instruction 1 in FIG. 5 may both be regarded as second instructions, and may be scheduled in parallel at the beginning of the loop.

Alternatively, the second instruction may be an instruction of which all predecessor instructions have been scheduled successfully. For example, in a case that an instruction 0 has been scheduled successfully, an instruction 2, an instruction 6, and an instruction 9 may all be regarded as second instructions ready for scheduling.

Then, the server may further screen the first instruction whose scheduling moment matches the current moment from the second instructions.

In addition, because an instruction having no predecessor instruction may be scheduled at the beginning of the loop regardless of whether another instruction is scheduled, the server may alternatively directly take the instruction having no predecessor instruction as the first instruction. This is not limited in the embodiments of this disclosure.

In some embodiments, the server may record the at least one first instruction in a first instruction queue, and record the at least one second instruction in a second instruction queue. The server may first record the at least one second instruction having no to-be-scheduled predecessor instruction in the second instruction queue, and then screen an instruction whose scheduling moment matches the current moment from the second instruction queue and recode the instruction in the first instruction queue. Subsequently, the server may directly select an instruction from the first instruction queue for scheduling.

The second instruction queue may be referred to as a suspended queue, which refers to a set of instructions whose predecessor instructions have been scheduled. The first instruction queue may be referred to as a ready queue, which refers to a set of instructions that can be scheduled at a current moment.

In some embodiments, the process of screening, by the server from the at least one second instruction, at least one first instruction whose scheduling moment matches the current moment includes: for any second instruction, at least one predecessor instruction of the second instruction is acquired; for any predecessor instruction, a scheduling moment of the predecessor instruction and first duration are acquired, the first duration being configured for representing duration from the scheduling moment of the predecessor instruction to a moment when an execution result of the predecessor instruction is transmitted to the second instruction; a second moment is determined based on the scheduling moment of the predecessor instruction and the first duration; and the second instruction is taken as the first instruction when the second moment of each predecessor instruction does not exceed the current moment.

The execution result of the predecessor instruction may be data obtained after the predecessor instruction is executed, or a resource vacated after the predecessor instruction is executed. The “resource” refers to a hardware resource that causes a conflict between the second instruction and the predecessor instruction. For example, execution of the second instruction and execution of the predecessor instruction require the same adder. During execution of the predecessor instruction, the adder is in a working state. After the predecessor instruction is executed, the adder is vacated and available for processing the second instruction.

According to the solution provided in the embodiments of this disclosure, the second moment corresponding to each predecessor instruction is determined according to the scheduling moment of the predecessor instruction and the first duration. Each second moment can accurately reflect a moment when the second instruction can be scheduled relative to the corresponding predecessor instruction. In a case that the second moment of each predecessor instruction corresponding to the second instruction does not exceed the current moment, it indicates that all predecessor instructions on which the second instruction depends have been executed, and the second instruction can acquire the execution result of each predecessor instruction, which provides a guarantee condition for subsequent scheduling of the second instruction, whereby scheduling can be performed accurately.

For example, it is assumed that the current moment is T, the current second instruction depends on m predecessor instructions, a start moment of each predecessor instruction is Ti, where i∈[1, m], and duration from the start moment of the predecessor instruction to a moment when the current second instruction acquires an execution result of the predecessor instruction is Li ticks. If any predecessor instruction satisfies Ti+Li≤T, it is considered that the current second instruction can participate in scheduling, and the second instruction is taken as the first instruction and recorded in the first instruction queue.

In addition, when an instruction does not depend on a predecessor instruction, the instruction can participate in scheduling.

In addition, the at least one second instruction may not include a second instruction whose scheduling moment matches the current moment. That is, at the current moment, the server may not screen the at least one first instruction from the at least one second instruction. In a case that the server does not acquire the first instruction, the server may directly perform operation 404. That is, in a case that the first instruction is not acquired, the server updates the current moment. Then, the server may search the at least one second instruction based on the updated current moment for a second instruction whose scheduling moment matches the updated current moment. Then, the server takes the second instruction whose scheduling moment matches the updated current moment as the first instruction.

403: The server processes the at least one first instruction, and determines whether each first instruction is capable of being scheduled successfully.

In the embodiments of this disclosure, for any first instruction, the server may process the first instruction, and determine whether the first instruction can be scheduled successfully. The server may detect resource occupation information of each first instruction ready for scheduling at the current moment, to determine whether a resource conflict exists between the first instructions ready for scheduling at the current moment. The resource mainly refers to a hardware resource in an AI chip. For example, if two first instructions ready for scheduling at the current moment require the same adder in the AI chip, it indicates that a resource conflict exists between the two first instructions.

Correspondingly, the process of processing, by the server, the at least one first instruction, and determining whether each first instruction is capable of being scheduled successfully includes: a target instruction that has not been scheduled currently and a third instruction that has been scheduled currently are acquired from the at least one first instruction; resource occupation information of the target instruction and resource occupation information of the third instruction are detected; and it is determined that the target instruction can be scheduled at the current moment when the resource occupation information of the target instruction does not conflict with the resource occupation information of the third instruction; or it is determined that the target instruction cannot be scheduled at the current moment when the resource occupation information of the target instruction conflicts with the resource occupation information of the third instruction.

The resource occupation information represents a hardware resource occupied when a corresponding instruction is executed. The third instruction is an instruction that is in the at least one first instruction and that has been scheduled currently.

According to the solution provided in the embodiments of this disclosure, hardware resources required by instructions ready for scheduling at the same moment are detected, which ensures that instructions having a resource conflict are not scheduled at the same moment, and ensures accuracy of subsequent instruction execution.

The server may take a first instruction that has a resource conflict with the third instruction as a second instruction and record the second instruction in the second instruction queue; and schedule a first instruction that does not have a resource conflict with the third instruction, that is, record the first instruction in a scheduled set. This is not limited in the embodiments of this disclosure.

Specifically, for any instruction, the server may form (construct) a scheduling information pair of the instruction by combining the instruction and a moment when the instruction is scheduled successfully. Then, the server stores the scheduling information pair of the instruction in the scheduled set. The scheduled set includes instructions that have been scheduled successfully.

According to the solution provided in the embodiments of this disclosure, the instruction and the moment when the instruction can be scheduled successfully are stored in the scheduled set, which facilitates subsequent detection of whether another instruction can be scheduled successfully, avoids repeated detection of the same instruction, and improves scheduling efficiency. Furthermore, a structure of the instructions is subsequently adjusted based on the moments recorded in the scheduled set.

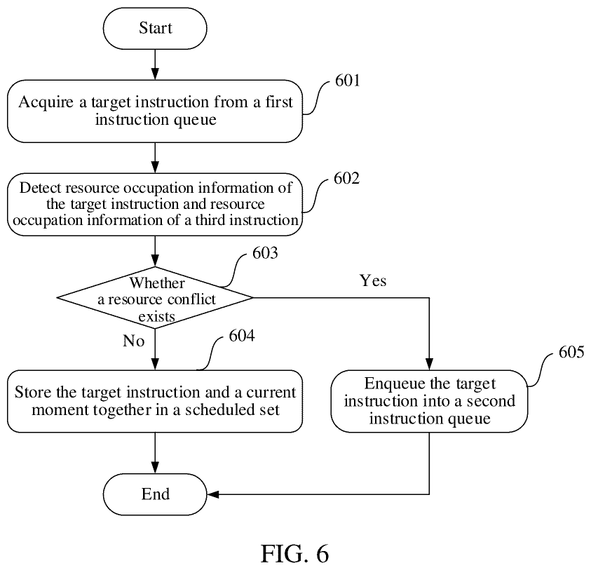

For example, FIG. 6 is a diagram of a first instruction processing process according to an embodiment of this application. Refer to FIG. 6. The process includes the following operations:

601: A server may acquire a target instruction that has not been scheduled currently from a first instruction queue.

The first instruction queue includes at least one first instruction, and is the foregoing ready queue, which refers to a set of instructions that can be scheduled at a current moment. In the first instruction processing process, some instructions (namely, third instructions) in the first instruction queue have been scheduled, and the other instructions (namely, target instructions) have not been scheduled.

602: The server detects resource occupation information of the target instruction and resource occupation information of a third instruction.

603: The server determines whether the resource occupation information of the target instruction conflicts with the resource occupation information of the third instruction, that is, determines whether a resource conflict exists between the target instruction and the third instruction.

604: The server may store the target instruction and a current moment together in a scheduled set when the resource occupation information of the target instruction does not conflict with the resource occupation information of the third instruction.

605: The server may enqueue the target instruction into a second instruction queue when the resource occupation information of the target instruction conflicts with the resource occupation information of the third instruction.

In some embodiments, the target instruction may be any instruction in the first instruction queue, or may be an instruction satisfying a preset condition. This is not limited in the embodiments of this disclosure. Five manners for acquiring a target instruction are exemplarily described below, but the manner for acquiring a target instruction is not limited thereto. The server may acquire a target instruction in at least one of the following manners.

Manner 1: The server may screen, from at least one first instruction, a first instruction whose corresponding node has a maximum height in a relationship graph, and take the first instruction as the target instruction.

When heights of a plurality of screened instructions are the same and are the maximum, the server may perform further screening in any one of the following manners. For example, when the heights of the plurality of instructions are the same and are the maximum, the first L first instructions in an instruction sequence are selected as the target instructions. L is a positive integer. That is, the server acquires the target instruction in a manner combining manner 1 and manner 5.

Manner 2: The server may screen, from the at least one first instruction, a first instruction whose corresponding node has a maximum number of successor nodes in the relationship graph, and take the first instruction as the target instruction.

Manner 3: The server may screen, from the at least one first instruction, a first instruction satisfying a target condition, and take the first instruction as the target instruction.

The target condition herein may be configured for specifying a particular instruction as the target instruction.

Manner 4: The server may screen, from the at least one first instruction, a first instruction that occupies a maximum number of resources during execution, and take the first instruction as the target instruction.

Manner 5: The server may screen, from the at least one first instruction, the first L first instructions in an instruction sequence, and take the first instructions as the target instructions.

404: The server updates the current moment, to obtain a first moment.

In the embodiments of this disclosure, after processing the at least one first instruction, the server may increase the current moment by unit time, to obtain the first moment. That is, after determining the instruction that can be scheduled at the current moment, the server increases the current moment by the unit time, to determine a next moment (of the current moment), and subsequently determines an instruction that can be scheduled at the next moment.

For example, if the current moment is T ticks and the unit time is 1 tick, the next moment is T+1 ticks.

405: The server determines a loop interval based on the first moment when determining that all the instructions in the instruction sequence are scheduled successfully.

In the embodiments of this disclosure, in a case that all the instructions in the instruction sequence are scheduled successfully, the server takes the first moment as the loop interval (a maximum time interval), which ensures that all instructions participating in a loop can be scheduled successfully within the loop interval. In a case that the instruction sequence still includes an instruction that is not scheduled successfully, the server repeatedly performs operation 402.

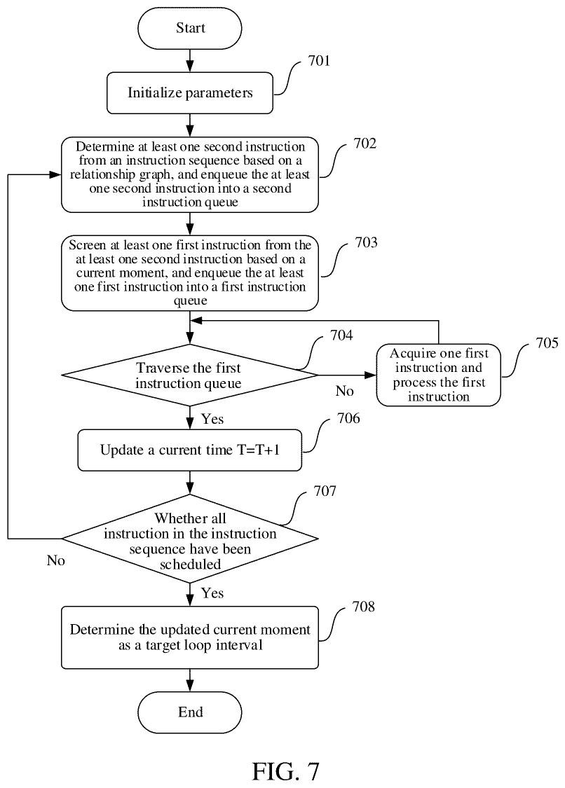

For example, FIG. 7 is a flowchart of a loop interval calculation process according to an embodiment of this application. Refer to FIG. 7. The process includes the following operations:

701: A server first initializes parameters.

Specifically, the server may establish an empty scheduled set, an empty first instruction queue, and an empty second instruction queue.

The server may further initialize a loop start moment T=0 tick.

702: The server determines at least one second instruction from an instruction sequence based on a relationship graph, the second instruction being an instruction having no to-be-scheduled predecessor instruction, including: an instruction having no predecessor instruction or an instruction whose predecessor instructions have been scheduled successfully; and the server enqueues the at least one second instruction into a second instruction queue.

703: The server screens, based on a current moment, at least one first instruction whose scheduling moment matches the current moment from the at least one second instruction.

That is, the server traverses the second instruction queue, screens the at least one first instruction from the second instruction queue, and enqueues the at least one first instruction into the first instruction queue.

When the first instruction cannot be screened based on the current moment, the server may update the current moment by using T=T+1. “1” refers to unit duration. Then, the server may perform screening again based on the updated current moment, to obtain at least one first instruction from the at least one second instruction.

704: The server traverses a first instruction queue.

705: The server sequentially selects one first instruction from the first instruction queue for processing, to obtain a processing result.

706: When completing traversal of the first instruction queue, the server may update the current moment by using T=T+1.

707: The server detects whether all instructions in the instruction sequence have been scheduled.

When all the instructions in the instruction sequence are scheduled successfully, the server determines the updated current moment as a target loop interval.

When the instruction sequence still includes an instruction that is not scheduled successfully, the server acquires a new second instruction.

The foregoing manner for calculating the loop interval may be regarded as a heuristic algorithm.

406: The server updates the loop interval by using a gradient descent method, and takes a previous loop interval as a target loop interval when the plurality of instructions are not capable of being scheduled successfully within an updated current loop interval, the target loop interval being configured for representing a minimum time interval within which the plurality of instructions are capable of being scheduled successfully.

In the embodiments of this disclosure, the server may adjust a scheduling sequence of the instructions based on related parameters such as the foregoing calculated loop interval, a height of a node, and a depth of the node. The server may gradually reduce the loop interval by using the gradient descent method, to update the loop interval.

Then, the server may sequentially search whether each instruction can be scheduled successfully by using a search algorithm according to the scheduling sequence of the instructions. The search algorithm may be a backtracking algorithm. This is not limited in the embodiments of this disclosure. That is, the server determines whether a resource conflict and an unreasonable dependency relationship exist between a current instruction and a scheduled instruction. In a case that the plurality of instructions participating in the loop can be scheduled successfully, the server continues to search, based on the updated loop interval, whether the plurality of instructions participating in the loop can be scheduled successfully. In a case that the plurality of instructions cannot be scheduled successfully for the first time within a current loop interval, the server takes a previous loop interval as the target loop interval.

In some embodiments, the server may further acquire scheduling information pairs of the plurality of instructions. Each scheduling information pair includes a corresponding instruction and a scheduling moment when the instruction is scheduled successfully. Then, the server adjusts a scheduling time sequence of the plurality of instruction in parallel loop iterations based on the scheduling information pairs of the plurality of instruction, that is, adjusts a structure of the plurality of instruction in a plurality of loop iterations, to minimize the target loop interval. For example, a number of instructions executed in parallel is maximized according to the scheduling moment when each instruction is scheduled successfully.

According to the solution provided in the embodiments of this disclosure, the structure of the plurality of instructions in the plurality of loop iterations is adjusted based on the instructions and the scheduling moments when the instructions are scheduled successfully, whereby execution duration of a target phase is always minimized. In this way, the instructions subjected to structure adjustment can be executed quickly, that is, a loop progress can be accelerated, and an instruction processing speed can be improved.

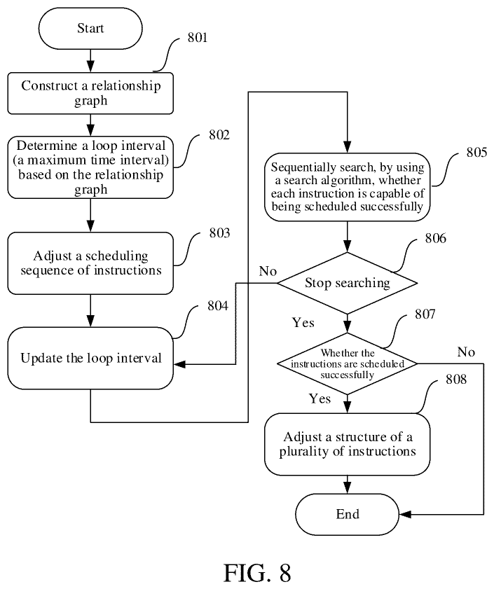

For example, FIG. 8 is a flowchart of modulo scheduling according to an embodiment of this application. Refer to FIG. 8. A server may apply the instruction processing method provided in the embodiments of this disclosure to modulo scheduling, which includes the following operations:

801: A server constructs a relationship graph based on an inputted instruction sequence.

802: The server determines a loop interval (namely, II) based on the relationship graph.

That is, the server determines, based on the relationship graph, a maximum time interval within which the same instruction is scheduled in two adjacent loop iterations.

803: The server may adjust a scheduling sequence of instructions based on the loop interval.

804: The server may gradually reduce the loop interval by using a gradient descent method, to update the loop interval.

For example, the server updates the loop interval in a manner of II=II-1. “1” refers to unit duration.

805: The server sequentially searches, by using a search algorithm, whether each instruction is capable of being scheduled successfully.

When a plurality of instructions participating in a loop can be scheduled successfully, the server continues to search, based on the updated loop interval, whether the plurality of instructions participating in the loop can be scheduled successfully.

806: The server stops searching when the plurality of instructions cannot be scheduled successfully for the first time within a current loop interval, takes a previous loop interval as a target loop interval, and determines that scheduling succeeds.

Alternatively, the server stops searching when a number of searches exceeds a preset value. After stopping searching, the server may determine whether the target loop interval is found.

808: When determining that the target loop interval exists, the server adjusts a structure of the plurality of instructions in a plurality of loop iterations based on the target loop interval; or when the target loop interval does not exist, the server keeps the original structure of the plurality of instructions unchanged.

The server may sequentially process all nodes shown in FIG. 5 by using the instruction processing method provided in the embodiments of this disclosure. Changes in the scheduled set, the first instruction queue, and the second instruction queue are shown in Table 1.

TABLE 1

| | | Second | First |
|---|---|---|---|
| | | instruction | instruction |
| Moment | Scheduled set | queue | queue |
| 0 | Empty | Empty | 0, 1 |
| 1 | 0, 1 | Empty | 2, 6, 8, 9, 10 |
| 2 | 0, 1, 2, 6, 9 | 3 | 8,10 |
| 3 | 0, 1, 2, 6, 8, 9, 10 | Empty | 3 |
| 4 | 0, 1, 2, 3, 6, 8, 9, 10 | 4 | Empty |
| 5 | 0, 1, 2, 3, 6, 8, 9, 10 | 4 | Empty |
| 6 | 0, 1, 2, 3, 6, 8, 9, 10 | 4 | Empty |
| 7 | 0, 1, 2, 3, 6, 8, 9, 10 | 4 | Empty |
| 8 | 0, 1, 2, 3, 6, 8, 9, 10 | 4 | Empty |
| 9 | 0, 1, 2, 3, 6, 8, 9, 10 | 4 | Empty |
| 10 | 0, 1, 2, 3, 6, 8, 9, 10 | 4 | Empty |
| 11 | 0, 1, 2, 3, 6, 8, 9, 10 | 4 | Empty |
| 12 | 0, 1, 2, 3, 6, 8, 9, 10 | 4 | Empty |
| 13 | 0, 1, 2, 3, 6, 8, 9, 10 | Empty | 4 |
| 14 | 0, 1, 2, 3, 4, 6, 8, 9, 10 | 5 | Empty |
| 15 | 0, 1, 2, 3, 4, 6, 8, 9, 10 | 5 | Empty |
| 16 | 0, 1, 2, 3, 4, 6, 8, 9, 10 | Empty | 5 |
| 17 | 0, 1, 2, 3, 4, 5, 6, 8, 9, 10 | 7 | v |
| 18 | 0, 1, 2, 3, 4, 5, 6, 8, 9, 10 | 7 | Empty |
| 19 | 0, 1, 2, 3, 4, 5, 6, 8, 9, 10 | 7 | Empty |
| 20 | 0, 1, 2, 3, 4, 5, 6, 8, 9, 10 | 7 | Empty |
| 21 | 0, 1, 2, 3, 4, 5, 6, 8, 9, 10 | 7 | Empty |
| 22 | 0, 1, 2, 3, 4, 5, 6, 8, 9, 10 | 7 | Empty |
| 23 | 0, 1, 2, 3, 4, 5, 6, 8, 9, 10 | 7 | Empty |
| 24 | 0, 1, 2, 3, 4, 5, 6, 8, 9, 10 | 7 | Empty |
| 25 | 0, 1, 2, 3, 4, 5, 6, 8, 9, 10 | 7 | Empty |
| 26 | 0, 1, 2, 3, 4, 5, 6, 8, 9, 10 | 7 | Empty |
| 27 | 0, 1, 2, 3, 4, 5, 6, 8, 9, 10 | 7 | Empty |
| 28 | 0, 1, 2, 3, 4, 5, 6, 8, 9, 10 | 7 | Empty |
| 29 | 0, 1, 2, 3, 4, 5, 6, 8, 9, 10 | Empty | 7 |
| 30 | 0, 1, 2, 3, 4, 5, 6, 7, 8, 9, 10 | 11 | Empty |
| 31 | 0, 1, 2, 3, 4, 5, 6, 7, 8, 9, 10 | 11 | Empty |
| 32 | 0, 1, 2, 3, 4, 5, 6, 7, 8, 9, 10 | Empty | 11 |
| 33 | 0, 1, 2, 3, 4, 5, 6, 7, 8, 9, 10, 11 | Empty | 12 |
| 34 | 0, 1, 2, 3, 4, 5, 6, 7, 8, 9, 10, 11, | Empty | Empty |
| | 12 | | |

Refer to Table 1.

(1) A server initializes a loop start moment T=0.

(2) As shown in FIG. 5, the node 0 and the node I have no predecessor node.

The server may enqueue the instructions corresponding to the node 0 and the node I into the second instruction queue.

(3) The server checks the node 0 and the node 1 in the second instruction queue. Because the node 0 and the node 1 have no predecessor node, both the node 0 and the node 1 can be enqueued into the first instruction queue, and a state is the state corresponding to the moment 0 in Table 1.

(4) The server selects, by using the instruction processing method provided in the embodiments of this disclosure, the node 0 that ranks front from the first instruction queue, and determines whether the node 0 can be enqueued in the scheduled set.

(5) Through a resource conflict check, it is determined that when the node 0 is executed at the moment 0, no resource conflict exists. Therefore, the server enqueues the instruction corresponding to the node 0 into the scheduled set, and a corresponding moment is 0. Similarly, the instruction corresponding to the node 1 may also be enqueued into the scheduled set, and a corresponding moment is also 0.

(6) The server updates a current moment T=0+1=1.

(7) In this case, because the node 0 and the node 1 are in the scheduled set, the node 2, the node 6, the node 8, the node 9, and the node 10 can all be enqueued into the second instruction queue.

(8) The server determines whether the node 2 can be enqueued into the first instruction queue.

The moment of the predecessor node 0 is 0, a delay from the node 0 to the node 2 is 1, and the two nodes satisfy a relationship defined by the formula “scheduling moment 0+delay 1=current moment 1”. Therefore, the node 2 can be enqueued into the first instruction queue. The “delay 1” means that duration from the scheduling moment of the instruction corresponding to the node 0 to a moment when the instruction corresponding to the node 2 acquires an execution result of the instruction corresponding to the node 0 is 1 unit duration.

(9) Similarly, the node 6, the node 8, the node 9, and the node 10 can all be enqueued into the first instruction queue, and a state is the state corresponding to the moment 1 in Table 1.

(10) It is determined that a height of the node 2 is the maximum. Therefore, whether the node 2 can be enqueued into the scheduled set is determined.

(11) Through a resource conflict check, it is determined that when the node 2 is executed at the moment 1, no resource conflict exists. Therefore, the node 2 is enqueued into the scheduled set, and a corresponding moment is 1.

Next, the node 6, the node 8, the node 9, and the node 10 are sequentially determined. Because a resource conflict does not exist between the node 6 and the node 9, the node 6 and the node 9 can be enqueued into the scheduled set. Because a resource conflict exists between the node 8 and the node 10, the node 8 and the node 10 are enqueued in the second instruction queue.

(12) The server updates the current moment T=1+1=2.

(13) In this case, because the node 2 that is a predecessor node of the node 3 is in the scheduled set, the server may enqueue the node 3 into the second instruction queue. In this case, the second instruction queue includes the node 3, the node 8, and the node 10.

(14) The server determines that the node 8 and the node 10 can be enqueued into the first instruction queue, and the node 3 is still in the second instruction queue, and a state is the state corresponding to the moment 2 in Table 1.

(15) The server sequentially determines that both the node 8 and the node 10 in the first instruction queue can be enqueued into the scheduled set.

(16) The server updates the current moment T=2+1=3.

(17) The server continues to process the instructions in this way until the moment 34 when all the nodes are enqueued into the scheduled set.

(18) The entire algorithm process is completed, and the server obtains the loop interval of 34.

Then, the server searches for the target loop interval in descending order according to the foregoing calculated loop interval of 34. A search process is shown in Table 2.

TABLE 2

| Serial | Loop | Number of | Scheduling |
|---|---|---|---|
| number | interval | searches | result |
| 1 | 34 | 232 | Success |
| 2 | 33 | 238 | Success |
| 3 | 32 | 244 | Success |
| 4 | 31 | 233 | Success |
| 5 | 30 | 248 | Success |
| 6 | 29 | 205 | Success |
| 7 | 28 | 225 | Success |
| 8 | 27 | 216 | Success |
| 9 | 26 | 239 | Success |
| 10 | 25 | 223 | Success |
| 11 | 24 | 228 | Success |
| 12 | 23 | 169 | Success |
| 13 | 22 | 162 | Success |
| 14 | 21 | 139 | Success |
| 15 | 20 | 184 | Success |
| 16 | 19 | 171 | Success |
| 17 | 18 | 138 | Success |
| 18 | 17 | 123768 | Fail |

Refer to Table 2.

(1) When the loop interval is equal to 34, it is determined that all instructions can be scheduled successfully. Specifically, all the instructions can be executed at moments (namely, issue moments) from a 0^{th} tick to a 33^{rd} tick while the instructions have no resource conflict and satisfy a data dependency relationship, and scheduling determination is performed on the instructions for a total of 232 times.

(2) When the server reduces the loop interval to 33, all the instructions can be scheduled successfully, and a number of searches is 238.

(3) When the server gradually reduces the loop interval until the loop interval is equal to 17, all the instructions cannot be scheduled successfully, and a total of 123768 searches are performed.

(4) The server finally determines that the target loop interval is equal to 18.

Finally, an instruction scheduling result obtained based on the target loop interval of 18 is taken as a final modulus scheduling result. A scheduling sequence of the instructions is shown below, in which the instructions that can be executed at the same moment are marked within the same braces:

{instruction 0}, {instruction 2}, {instruction 3}, {instruction 10}, {instruction 1, instruction 7}, {instruction 8}, {instruction 12, instruction 4}, {instruction 11}, {instruction 5}, {instruction 9}.

The foregoing instructions may be sourced from a common operator Swish. To improve parallelism of the instructions participating in the loop, a core loop of Swish is unrolled four times in advance.

The following compares effects of the method of testing loop intervals one by one from the lower bound in ascending order in the related technology and the solution provided in the embodiments of this disclosure in module scheduling.

Specific test parameters are set as follows: a number of instructions is 46; search algorithms are all backtracking algorithms; a maximum number of searches is limited to 820000; and a number of server cores is 84.

First, it is determined through the method in the related technology and the solution provided in the embodiments of this disclosure that a target loop interval within which all instructions are scheduled successfully is 22 ticks.

It can be learned that the target loop intervals obtained by the two methods are the same, that is, the two methods have the same search capability.

Then, time consumed by the method in the related technology and the solution provided in the embodiments of this disclosure for searching for the target loop interval is compared. Results are shown in Table 3.

TABLE 3

| | Related technology | Solution in embodiments of |
|---|---|---|
| Test number | (second) | this disclosure (second) |
| 1 | 11.699 | 3.665 |
| 2 | 11.574 | 3.685 |
| 3 | 11.499 | 3.734 |
| 4 | 11.133 | 3.709 |
| 5 | 11.293 | 3.907 |
| Average time | 11.4396 | 3.74 |
| consumption (second) | | |

It can be learned from Table 3 that, in a case of the same search capability, time consumption of the solution provided in the embodiments of this disclosure is reduced from 11.4 seconds to 3.7 seconds, which is reduced by 67.5%, and a search speed is significantly improved.

Finally, a number of searches required by the method in the related technology is compared with a number of searches required by the solution provided in the embodiments of this disclosure, and results are shown in Table 4 and Table 5. Table 4 shows the number of searches required by the method in the related technology. Table 5 shows the number of searches required by the solution provided in the embodiments of this disclosure.

TABLE 4

| | Loop | Number of searches required |
|---|---|---|
| Test number | interval | by related technology |
| 1 | 15 | 392428 |
| 2 | 16 | 454147 |
| 3 | 17 | 520274 |
| 4 | 18 | 590809 |
| 5 | 19 | 665752 |
| 6 | 20 | 745103 |
| 7 | 21 | 820000 |
| 8 | 22 | 25905 |

| | |
|---|---|
| Average number of searches | 523564 |
| Total number of searches | 4214418 |

TABLE 5

| | Loop | Number of searches required |
|---|---|---|
| Test number | interval | by this application |
| 1 | 42 | 1135 |
| 2 | 41 | 1221 |
| 3 | 40 | 1235 |
| 4 | 39 | 1237 |
| 5 | 38 | 1312 |
| 6 | 37 | 1358 |
| 7 | 36 | 1282 |
| 8 | 35 | 1357 |
| 9 | 34 | 1349 |
| 10 | 33 | 1455 |
| 11 | 32 | 1307 |
| 12 | 31 | 1509 |
| 13 | 30 | 1463 |
| 14 | 29 | 1439 |
| 15 | 28 | 1397 |
| 16 | 27 | 1654 |
| 17 | 26 | 1739 |
| 18 | 25 | 2209 |
| 19 | 24 | 2975 |
| 20 | 23 | 26758 |
| 21 | 22 | 25825 |
| 22 | 21 | 820000 |

| | |
|---|---|
| Average number of searches | 3692 |
| Total number of searches | 901216 |

It can be learned from Table 4 and Table 5 that, the total number of searches required by the solution provided in the embodiments of this disclosure is reduced from 4214418 to 901216, which is reduced by 78.6%. Therefore, the total search time is significantly reduced.

In addition, according to the method in the related technology, although a total of eight values from 15 to 22 need to be searched, the average number of searches is 523564 because the first seven searches fail.

According to the solution provided in the embodiments of this disclosure, a total of 22 values from 42 to 21 need to be searched, but the search fails only when the loop interval is 21. Therefore, the average number of searches is only 3692, and the number of searches within a single loop interval is reduced by 99.3%.

Different manners for acquiring a target instruction are adopted in operation 403, which result in different time consumption and number of searches. Results are shown in Table 6 and Table 7.

TABLE 6

| | | | Time |
|---|---|---|---|
| | Time | | consumption |
| | consumption | Time | (second) of |
| | of related | consumption | another manner |
| | technology | (second) (manner | (manner 2, |
| Test number | (second) | 1 + manner 5) | 3, or 4) |
| 1 | 11.699 | 3.665 | 3.625 |
| 2 | 11.574 | 3.685 | 3.602 |
| 3 | 11.499 | 3.734 | 3.549 |
| 4 | 11.133 | 3.709 | 3.728 |
| 5 | 11.293 | 3.907 | 3.661 |
| Average time | 11.4396 | 3.74 | 3.633 |
| consumption | | | |
| (second) | | | |

It can be learned from Table 6 that time consumption of the different manners provided in operation 403 is different but substantially the same.

TABLE 7

| | Loop | Number of searches of another |
|---|---|---|
| Test number | interval | manner (manner 2, 3, or 4) |
| 1 | 39 | 1237 |
| 2 | 38 | 1312 |
| 3 | 37 | 1358 |
| 4 | 36 | 1282 |
| 5 | 35 | 1357 |
| 6 | 34 | 1349 |
| 7 | 33 | 1455 |
| 8 | 32 | 1307 |
| 9 | 31 | 1509 |
| 10 | 30 | 1463 |
| 11 | 29 | 1439 |
| 12 | 28 | 1397 |
| 13 | 27 | 1654 |
| 14 | 26 | 1739 |
| 15 | 25 | 2209 |
| 16 | 24 | 2975 |
| 17 | 23 | 26758 |
| 18 | 22 | 25825 |
| 19 | 21 | 820000 |

| | |
|---|---|
| Average number of searches | 4086 |
| Total number of searches | 897625 |

It can be learned from Table 7 that, through another manner provided in operation 403, such as manner 2, manner 3, or manner 4, the loop interval is reduced from 42 to 39, and the number of node searches is reduced by 3591, but the manner has little impact on time consumption of the overall loop interval search. Therefore, the manner for acquiring a target instruction provided in the embodiment of this application may be randomly selected, which does not significantly affect the overall effect.

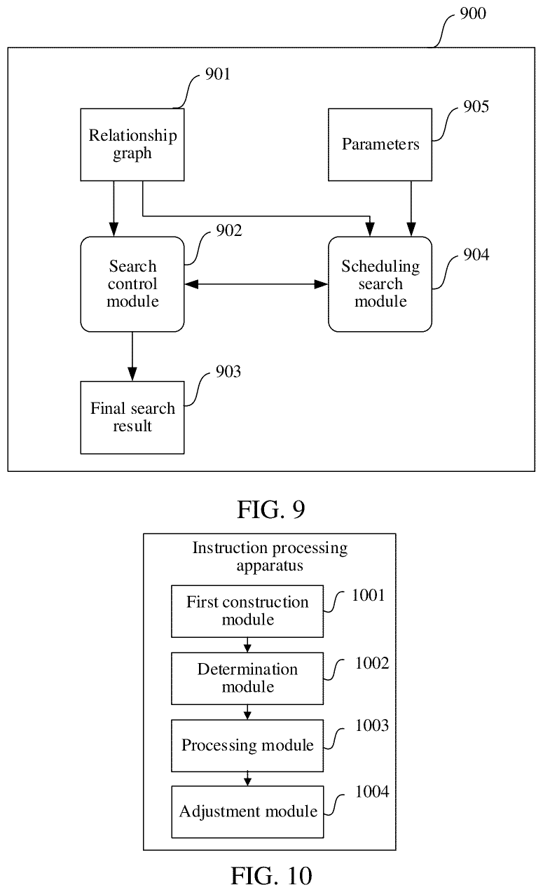

To describe the instruction processing method provided in the embodiments of this disclosure more clearly, the following further describes the instruction processing method with reference to the accompanying drawings. FIG. 9 is an architectural diagram of an instruction processing system 900 according to an embodiment of this application. Refer to FIG. 9. A core module in the instruction processing system 900 is a search control module 902. The search control module 902 is responsible for calculating a maximum loop interval and controlling a search process of a target loop interval. An input of the search control module is a relationship graph 901 representing a dependency relationship among instructions, and a final search result 903 is outputted, which includes a target loop interval and a corresponding instruction scheduling result. The instruction scheduling result includes an instruction and a moment when the instruction is scheduled successfully based on the target loop interval.

The search control module 902 is connected to a scheduling search module 904. The search control module 902 may transmit a to-be-tested current loop interval for scheduling and receive a result returned by the scheduling search module 904.

FIG. 10 is a block diagram of an instruction processing apparatus according to an embodiment of this application. The instruction processing apparatus is configured to perform the operations of the foregoing instruction processing method. Refer to FIG. 10. The instruction processing apparatus includes: a first construction module 1001, a determination module 1002, a processing module 1003, and an adjustment module 1004.

The first construction module 1001 is configured to acquire an instruction sequence, and construct a relationship graph of the instruction sequence, the instruction sequence including a plurality of instructions for loop execution, nodes in the relationship graph being configured for representing the instructions in the instruction sequence, and an edge connecting two nodes in the relationship graph being configured for representing a dependency relationship between two instructions corresponding to the two nodes.

The determination module 1002 is configured to determine a loop interval based on the relationship graph, the loop interval being configured for representing a maximum time interval within which the same instruction is scheduled in two adjacent loop iterations.

The processing module 1003 is configured to gradually reduce the loop interval, and determine a previous loop interval as a target loop interval when the plurality of instructions are not capable of being scheduled successfully for the first time within a current loop interval.

The adjustment module 1004 is configured to adjust a scheduling time sequence of the plurality of instructions in parallel loop iterations based on the target loop interval, and load the adjusted instructions onto a chip for running.

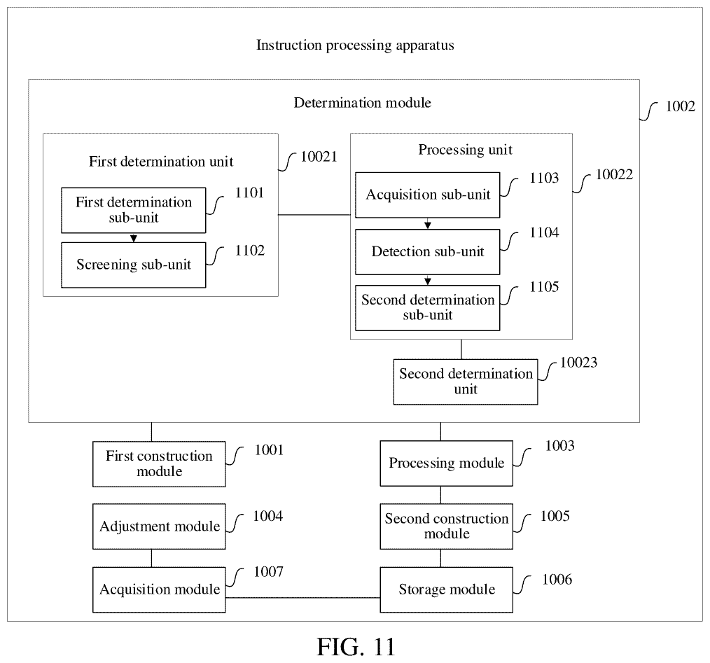

In some embodiments, FIG. 11 is a block diagram of another instruction processing apparatus according to an embodiment of this application. Refer to FIG. 11. A determination module 1002 includes:
a first determination unit 10021, configured to determine at least one first instruction capable of participating in scheduling currently from the instruction sequence based on the relationship graph and a current moment, the first instruction having no to-be-scheduled predecessor instruction, and the current moment matching a scheduling moment of the first instruction;
a processing unit 10022, configured to process the at least one first instruction, and determine whether each first instruction is capable of being scheduled successfully; and
a second determination unit 10023, configured to determine the loop interval based on a next moment when it is determined that all the instructions in the instruction sequence are scheduled successfully at the current moment.

Refer to FIG. 11 again. In some embodiments, the first determination unit 10021 includes:
a first determination sub-unit 1101, configured to determine at least one second instruction having no to-be-scheduled predecessor instruction from the instruction sequence based on the relationship graph; and
a screening sub-unit 1102, configured to screen the at least one first instruction whose scheduling moment matches the current moment from the at least one second instruction.

Refer to FIG. 11 again. In some embodiments, the screening sub-unit 1102 is configured to acquire, for any second instruction, at least one predecessor instruction of the second instruction;
acquire, for any predecessor instruction, a scheduling moment of the predecessor instruction and first duration, the first duration being configured for representing duration from the scheduling moment of the predecessor instruction to a moment when an execution result of the predecessor instruction is transmitted to the second instruction;
determine a second moment based on the scheduling moment of the predecessor instruction and the first duration; and
take the second instruction as the first instruction when the second moment of each predecessor instruction does not exceed the current moment.

Refer to FIG. 11 again. In some embodiments, the processing unit 10022 includes:
an acquisition sub-unit 1103, configured to acquire a target instruction that has not been scheduled currently and a third instruction that has been scheduled currently from the at least one first instruction;
a detection sub-unit 1104, configured to detect resource occupation information of the target instruction and resource occupation information of the third instruction; and
a second determination sub-unit 1105, configured to determine that the target instruction is capable of being scheduled at the current moment when the resource occupation information of the target instruction does not conflict with the resource occupation information of the third instruction; or
determine that the target instruction is not capable of being scheduled at the current moment when the resource occupation information of the target instruction conflicts with the resource occupation information of the third instruction.

Refer to FIG. 11 again. In some embodiments, the acquisition sub-unit 1103 is configured to perform at least one of the following:
screen, from the at least one first instruction, a first instruction whose corresponding node has a maximum height in the relationship graph, and take the first instruction as the target instruction;
screen, from the at least one first instruction, a first instruction whose corresponding node has a maximum number of successor nodes in the relationship graph, and take the first instruction as the target instruction;
screen, from the at least one first instruction, a first instruction that occupies a maximum number of resources during execution, and take the first instruction as the target instruction; and
screen, from the at least one first instruction, the first L first instructions in the instruction sequence, and take the first instructions as the target instructions, L being a positive integer.

Refer to FIG. 11 again. In some embodiments, the apparatus further includes:
a second construction module 1005, configured to combine, for any instruction, the instruction and a moment when the instruction is scheduled successfully into a scheduling information pair of the instruction; and
a storage module 1006, configured to store the scheduling information pair in a scheduled set.

Refer to FIG. 11 again. In some embodiments, the apparatus further includes:
an acquisition module 1007, configured to acquire scheduling information pairs of the plurality of instructions, each scheduling information pair including one instruction and a scheduling moment when the instruction is scheduled successfully,
the adjustment module 1004 being further configured to adjust the scheduling time sequence of the plurality of instructions in the parallel loop iterations based on the scheduling information pairs of the plurality of instructions, to minimize the target loop interval.

The embodiments of this disclosure provide the instruction processing apparatus. The relationship graph is constructed based on the instruction sequence that includes the plurality of instructions participating in the loop, whereby the dependency relationship among the plurality of instructions participating in the loop can be determined clearly. Then, according to the dependency relationship among the plurality of instructions in the relationship graph, the duration required for sequentially scheduling the plurality of instructions in the single loop iteration, namely, the loop interval, is calculated, and the loop interval is taken as the maximum time interval between two adjacent loop iterations, which ensures that all the instructions participating in the loop can be scheduled successfully within the loop interval (the maximum time interval). Then, the loop interval is gradually reduced by using a gradient descent method, and all the instructions participating in the loop are scheduled based on each reduced loop interval. In a case that a scheduling failure occurs within a current loop interval, a previous loop interval is taken as the target loop interval, to ensure that all the instructions participating in the loop can be scheduled successfully within the target loop interval. In this way, a minimum loop interval can be found by gradually searching downward from a maximum loop interval within which successful scheduling can be ensured. Because time consumption of successful scheduling of the instructions is typically low, the foregoing method can improve efficiency of acquiring the target loop interval, which is beneficial to subsequent rapid adjustment of the structure of the plurality of instructions in a plurality of loop iterations according to the target loop interval. In this way, the instructions subjected to structure adjustment can be executed quickly, that is, a loop progress can be accelerated, and an instruction processing speed can be improved.

In addition, when the interaction processing apparatus provided in the foregoing embodiments runs an application program, only division of the foregoing functional modules is taken as an example for description. In practical application, the foregoing functions may be assigned to and completed by different modules as needed, that is, the internal structure of the apparatus is divided into different functional modules to implement all or some of the functions described above. In addition, the instruction processing apparatus provided in the foregoing embodiments and the instruction processing method embodiments belong to the same conception. For a specific implementation process, refer to the method embodiments. Details are not described herein again.

In the embodiments of this disclosure, a computer device can be configured as a terminal or a server. When the computer device is configured as a terminal, the technical solutions provided in the embodiments of this disclosure may be implemented by the terminal serving as an execution entity. When the computer device is configured as a server, the technical solutions provided in the embodiments of this disclosure may be implemented by the server serving as an execution entity. Alternatively, the technical solutions provided in the embodiments of this disclosure may be implemented through interaction between a terminal and a server. This is not limited in the embodiments of this disclosure.

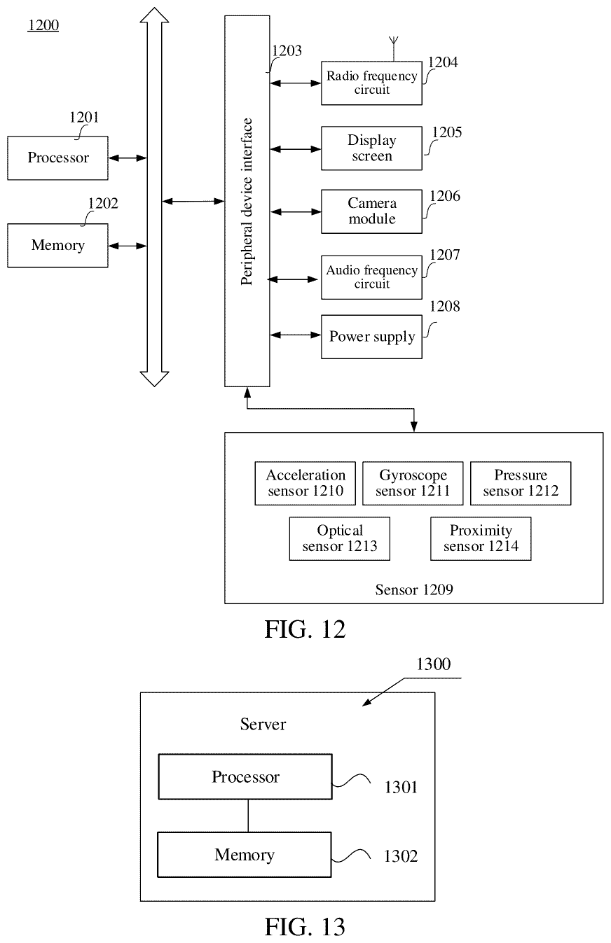

FIG. 12 is a structural block diagram of a terminal according to an embodiment of this application. A terminal 1200 may be a portable mobile terminal such as a smartphone, a tablet computer, a Moving Picture Experts Group Audio Layer III (MP3) player, a Moving Picture Experts Group Audio Layer IV (MP4) player, a laptop computer, or a desktop computer. Alternatively, the terminal 1200 may be referred to by another name such as a user device, a portable terminal, a laptop terminal, or a desktop terminal.

Typically, the terminal 1200 includes: a processor 1201 and a memory 1202.

The processor 1201 may include one or more processing cores, such as a 4-core processor or an 8-core processor. The processor 1201 may be implemented in at least one hardware form including a digital signal processor (DSP), a field-programmable gate array (FPGA), and a programmable logic array (PLA). Alternatively, the processor 1201 may include a main processor and a coprocessor. The main processor is configured to process data in an active state, also referred to as a central processing unit (CPU). The coprocessor is a low-power processor configured to process the data in a standby state. In some embodiments, the processor 1201 may be integrated with a graphics processing unit (GPU). The GPU is configured to render and draw content that needs to be displayed on a display screen. In some embodiments, the processor 1201 may further include an AI processor. The AI processor is configured to process computing operations related to ML.

The memory 1202 may include one or more computer-readable storage media. The computer-readable storage medium may be non-transient. The memory 1202 may further include a high-speed random-access memory (RAM) and a non-volatile memory, such as one or more disk storage devices or flash storage devices. In some embodiments, the non-transient computer-readable storage medium in the memory 1202 is configured to store at least one computer program. The processor 1201 executes the at least one computer program to implement the instruction processing method provided in the method embodiments of this disclosure.

In some embodiments, the terminal 1200 may further include: a peripheral device interface 1203 and at least one peripheral device. The processor 1201, the memory 1202, and the peripheral device interface 1203 may be connected via a bus or a signal cable. Each peripheral device may be connected to the peripheral device interface 1203 via a bus, a signal cable, or a circuit board. Specifically, the peripheral device may include at least one of a radio frequency (RF) circuit 1204, a display screen 1205, a camera module 1206, an audio frequency circuit 1207, and a power supply 1208.

The peripheral device interface 1203 may be configured to connect at least one peripheral device related to input/output (I/O) to the processor 1201 and the memory 1202. In some embodiments, the processor 1201, the memory 1202, and the peripheral device interface 1203 are integrated on the same chip or circuit board. In some other embodiments, any one or two of the processor 1201, the memory 1202, and the peripheral device interface 1203 may be implemented on an independent chip or circuit board. This is not limited in this embodiment.

The RF circuit 1204 is configured to receive and transmit an RF signal, also referred to as an electromagnetic signal. The RF circuit 1204 communicates with a communication network and another communication device through the electromagnetic signal. The RF circuit 1204 converts an electric signal into an electromagnetic signal for transmission, or converts a received electromagnetic signal into an electric signal. In some embodiments, the RF circuit 1204 includes: an antenna and feeder system, an RF transceiver, one or more amplifiers, a tuner, an oscillator, a DSP, a codec chipset, a user identity module card, and the like. The RF circuit 1204 may communicate with another terminal by using at least one wireless communication protocol. The wireless communication protocol includes, but is not limited to, a world wide web, a metropolitan area network, an intranet, generations of mobile communication networks (2G, 3G, 4G, and 5G), a wireless local area network and/or a Wireless Fidelity (Wi-Fi) network. In some embodiments, the RF circuit 1204 may further include a circuit related to near field communication (NFC). This is not limited in this application.

The display screen 1205 is configured to display a user interface (UI). The UI may include a graph, text, an icon, a video, and any combination thereof. In a case that the display screen 1205 is a touch display screen, the display screen 1205 further has a capability of acquiring a touch signal on or above a surface of the display screen 1205. The touch signal may be inputted into the processor 1201 as a control signal for processing. In this case, the display screen 1205 may be further configured to provide a virtual button and/or a virtual keyboard, also referred to as a soft button and/or a soft keyboard. In some embodiments, one display screen 1205 may be disposed on a front panel of the terminal 1200. In some other embodiments, at least two display screens 1205 are respectively disposed on different surfaces of the terminal 1200 or in a folded design. In some other embodiments, the display screen 1205 may be a flexible display screen arranged on a curved surface or a folded surface of the terminal 1200. Even, the display screen 1205 may be further arranged in a non-rectangular irregular pattern, namely, a special-shaped screen. The display screen 1205 can be manufactured by using a liquid crystal display (LCD), an organic light-emitting diode (OLED), or the like.

The camera module 1206 is configured to capture images or videos. In some embodiments, the camera module 1206 includes a front-facing camera and a rear-facing camera. Typically, the front-facing camera is disposed on the front panel of the terminal, and the rear-facing camera is disposed on a back surface of the terminal. In some embodiments, at least two rear-facing cameras are arranged, which are respectively any of a main camera, a depth-of-field camera, a wide-angle camera, and a telephoto camera, to achieve background blur through integration of the main camera and the depth-of-field camera, panoramic photographing and virtual reality (VR) photographing through integration of the main camera and the wide-angle camera, or other integrated photographing functions. In some embodiments, the camera module 1206 may further include a flash. The flash may be a monochrome temperature flash, or may be a double color temperature flash. The double color temperature flash refers to a combination of a warm light flash and a cold light flash, and may be used for light compensation under different color temperatures.

The audio frequency circuit 1207 may include a microphone and a speaker. The microphone is configured to acquire sound waves of a user and an environment, convert the sound waves into electrical signals, and input the electrical signals into the processor 1201 for processing, or input the electrical signals into the RF circuit 1204 for implementing voice communication. For the purpose of stereo acquisition or noise reduction, a plurality of microphones are respectively disposed at different portions of the terminal 1200. The microphone may further be an array microphone or an omni-directional acquisition type microphone. The speaker is configured to convert electric signals from the processor 1201 or the RF circuit 1204 into sound waves. The speaker may be a conventional film speaker, or may be a piezoelectric ceramic speaker. When the speaker is a piezoelectric ceramic speaker, the speaker may not only convert electric signals into sound waves audible to a human being, but also convert electric signals into sound waves inaudible to a human being for purposes of ranging and the like. In some embodiments, the audio frequency circuit 1207 may further include an earphone jack.

The power supply 1208 is configured to supply power to components in the terminal 1200. The power supply 1208 may be an alternating current, a direct current, a primary battery, or a rechargeable battery. When the power supply 1208 includes a rechargeable battery, and the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the terminal 1200 further includes one or more sensors 1209. The one or more sensors 1209 include, but are not limited to, an acceleration sensor 1210, a gyroscope sensor 1211, a pressure sensor 1212, an optical sensor 1213, and a proximity sensor 1214.

The acceleration sensor 1210 may detect a magnitude of acceleration on three coordinate axes of a coordinate system established based on the terminal 1200. For example, the acceleration sensor 1210 may be configured to detect components of gravity acceleration on the three coordinate axes. The processor 1201 may control, based on a gravity acceleration signal acquired by the acceleration sensor 1210, the display screen 1205 to display the UI in a landscape view or a portrait view. The acceleration sensor 1210 may be further configured to acquire motion data of a game or a user.

The gyroscope sensor 1211 may detect a body direction and a rotation angle of the terminal 1200. The gyroscope sensor 1211 may cooperate with the acceleration sensor 1210 to acquire a three-dimensional (3D) action of the user for the terminal 1200. The processor 1201 may implement the following functions according to the data acquired by the gyroscope sensor 1211: motion sensing (such as changing the UI according to a tilt operation of the user), image stabilization at shooting, game control, and inertial navigation.

The pressure sensor 1212 may be disposed at a side frame of the terminal 1200 and/or a lower layer of the display screen 1205. When disposed at the side frame of the terminal 1200, the pressure sensor 1212 may detect a holding signal of the user on the terminal 1200. The processor 1201 performs left/right hand recognition or a quick operation according to the holding signal acquired by the pressure sensor 1212. When the pressure sensor 1212 is disposed on the lower layer of the display screen 1205, the processor 1201 controls an operable control on the UI based on a pressure operation of the user for the display screen 1205. The operable control includes at least one of a button control, a scroll-bar control, an icon control, and a menu control.

The optical sensor 1213 is configured to acquire ambient light intensity. In an embodiment, the processor 1201 may control the display brightness of the display screen 1205 according to the ambient light intensity acquired by the optical sensor 1213. Specifically, when the ambient light intensity is relatively high, the display brightness of the display screen 1205 is increased; or when the ambient light intensity is relatively low, the display brightness of the display screen 1205 is decreased. In another embodiment, the processor 1201 may further dynamically adjust shooting parameters of the camera module 1206 according to the ambient light intensity acquired by the optical sensor 1213.

The proximity sensor 1214, also referred to as a distance sensor, is typically disposed on the front panel of the terminal 1200. The proximity sensor 1214 is configured to acquire a distance between the user and the front surface of the terminal 1200. In an embodiment, when the proximity sensor 1214 detects that the distance between the user and the front surface of the terminal 1200 is gradually decreased, the processor 1201 controls the display screen 1205 to switch from a screen-on state to a screen-off state; or when the proximity sensor 1214 detects that the distance between the user and the front surface of the terminal 1200 is gradually increased, the processor 1201 controls the display screen 1205 to switch from the screen-off state to the screen-on state.

A person skilled in the art will appreciate that the structure shown in FIG. 12 does not limit the terminal 1200 and may include more or fewer components than shown in the figure, or some components are combined, or a different component arrangement is adopted.

FIG. 13 is a schematic structural diagram of a server according to an embodiment of this application. A server 1300 may vary considerably depending on configuration or performance, and may include one or more CPUs 1301 and one or more memories 1302. Each memory 1302 has at least one computer program stored therein. Each CPU 1301 loads and executes the at least one computer program to implement the instruction processing method provided in the foregoing method embodiments. It is clear that the server may further include components such as a wired or wireless network interface, a keyboard, and an I/O interface, to implement I/O. The server may further include another component configured to implement a device function. Details are not described herein.

The embodiments of this disclosure further provide a computer-readable storage medium, which has at least one computer program stored therein. A processor of a computer device loads and executes the at least one computer program to implement the operations performed by the computer device in the instruction processing method provided in the foregoing embodiments. For example, the computer-readable storage medium may be a read-only memory (ROM), a RAM, a compact disc read-only memory (CD-ROM), a magnetic tape, a floppy disk, an optical data storage device, or the like.

The embodiments of this disclosure further provide a chip, which includes a programmable logic circuit and/or program instructions. When run on a computer device, the chip is configured to implement the instruction processing method provided in the embodiments of this disclosure.

The embodiments of this disclosure further provide a computer program product, which includes a computer program. The computer program is stored in a computer-readable storage medium. A processor of a computer device reads the computer program from the computer-readable storage medium, and executes the computer program, to cause the computer device to perform the instruction processing method provided in the exemplary implementations.

A person of ordinary skill in the art will appreciate that all or some of the operations in the foregoing embodiments may be implemented by hardware or implemented by a program instructing relevant hardware. The program may be stored in a computer-readable storage medium. The storage medium may be a ROM, a magnetic disk, an optical disc, or the like.

The foregoing descriptions are merely exemplar embodiments of this disclosure, but are not intended to limit this application. Any modification, equivalent replacement, or improvement made within the spirit and principle of this application falls within the scope of protection of this application.

What is claimed is:

1. An instruction processing method, performed by a computer device and comprising:
acquiring an instruction sequence, and constructing a relationship graph of the instruction sequence, the instruction sequence comprising a plurality of instructions for loop execution, each of a plurality of nodes in the relationship graph representing a respective instruction in the instruction sequence, and an edge connecting two nodes in the relationship graph representing a dependency relationship between two instructions corresponding to the two nodes;
wherein nodes of the dependency graph represent respective instructions in the instruction sequence,
determining, based on the relationship graph, a loop interval representing a maximum time interval for a current loop within which the same instruction is scheduled in two adjacent loop iterations;
progressively reducing the loop interval and, upon failing to successfully schedule the plurality of instructions within the current loop for the first time, determining an interval of a previous loop as a target loop interval for the current loop; and
adjusting a scheduling time sequence of the plurality of instructions in parallel loop iterations based on the target loop interval, and loading the adjusted instructions onto a chip for execution.

2. The method according to claim 1, wherein determining a loop interval based on the relationship graph comprises:
determining, from the instruction sequence and based on the relationship graph and a current moment, at least one first instruction that is currently eligible for scheduling, each of the first instruction having no unscheduled predecessor instruction, and the current moment matching a scheduling moment of the first instruction;
processing each of the at least one first instruction, and determining whether each of the at least one first instruction can be scheduled successfully; and
determining the loop interval based on a next moment when it is determined that all instructions in the instruction sequence have been successfully scheduled at the current moment.

3. The method according to claim 2, wherein determining the at least one first instruction that is currently eligible for scheduling comprises:
determining at least one second instruction having no unscheduled predecessor instruction from the instruction sequence based on the relationship graph; and
selecting, from the at least one second instruction, the at least one first instruction whose scheduling moment matches the current moment.

4. The method according to claim 3, wherein selecting the at least one first instruction comprises:
acquiring, for each of the at least one second instruction, a predecessor instruction of the each of the at least one second instruction;
acquiring, for the predecessor instruction, a scheduling moment of the predecessor instruction and a first duration, the first duration representing a duration from the scheduling moment of the predecessor instruction to a moment when an execution result of the predecessor instruction is transmitted to the each of the at least one second instruction;
determining a second moment based on the scheduling moment of the predecessor instruction and the first duration; and
designating the second instruction as the at least one first instruction when the second moment of the predecessor instruction does not exceed the current moment.

5. The method according to claim 2, wherein processing the each of the at least one first instruction comprises:
acquiring a target instruction that has not yet been scheduled and a third instruction that has been scheduled currently from the at least one first instruction;
detecting resource occupation information of the target instruction and resource occupation information of the third instruction; and
determining that the target instruction can be scheduled at the current moment when the resource occupation information of the target instruction does not conflict with the resource occupation information of the third instruction; or
determining that the target instruction cannot be scheduled at the current moment when the resource occupation information of the target instruction conflicts with the resource occupation information of the third instruction.

6. The method according to claim 5, wherein the acquiring the target instruction comprises at least one of the following:
selecting, from the at least one first instruction, a first instruction whose corresponding node has a maximum height in the relationship graph, and taking the first instruction as the target instruction;
selecting, from the at least one first instruction, a first instruction whose corresponding node has a maximum number of successor nodes in the relationship graph, and taking the first instruction as the target instruction;
selecting, from the at least one first instruction, a first instruction that occupies a maximum number of resources during execution, and taking the first instruction as the target instruction; or
selecting, from the at least one first instruction, the first L first instructions in the instruction sequence, and taking the first instructions as the target instructions, L being a positive integer.

7. The method according to claim 1, further comprising:
combining, for each instruction in the instruction sequence, the each instruction and a moment when the each instruction is successfully scheduled into a scheduling information pair corresponding to the each instruction; and
storing the scheduling information pair in a scheduled set.

8. The method according to claim 7, further comprising:
acquiring scheduling information pairs of the plurality of instructions, each scheduling information pair comprising an instruction and a corresponding scheduling moment at which the instruction is successfully scheduled; and
adjusting the scheduling time sequence of the plurality of instructions in the parallel loop iterations based on the scheduling information pairs of the plurality of instructions, to minimize the target loop interval.

9. A device comprising a memory for storing computer instructions and a processor in communication with the memory, wherein, when the processor executes the computer instructions, the processor is configured to cause the device to:
acquire an instruction sequence, and constructing a relationship graph of the instruction sequence, the instruction sequence comprising a plurality of instructions for loop execution, each of a plurality of nodes in the relationship graph representing a respective instruction in the instruction sequence, and an edge connecting two nodes in the relationship graph representing a dependency relationship between two instructions corresponding to the two nodes;
determine, based on the relationship graph, a loop interval representing a maximum time interval for a current loop within which the same instruction is scheduled in two adjacent loop iterations;
progressively reduce the loop interval and, upon failing to successfully schedule the plurality of instructions within the current loop for the first time, determine an interval of a previous loop as a target loop interval for the current loop; and
adjust a scheduling time sequence of the plurality of instructions in parallel loop iterations based on the target loop interval, and loading the adjusted instructions onto a chip for execution.

10. The device according to claim 9, wherein, when the processor is configured to cause the device to determine the loop interval based on the relationship graph, the processor is configured to cause the device to:
determine, from the instruction sequence and based on the relationship graph and a current moment, at least one first instruction that is currently eligible for scheduling, each of the first instruction having no unscheduled predecessor instruction, and the current moment matching a scheduling moment of the first instruction;
process each of the at least one first instruction, and determining whether each of the at least one first instruction can be scheduled successfully; and
determine the loop interval based on a next moment when it is determined that all instructions in the instruction sequence have been successfully scheduled at the current moment.

11. The device according to claim 10, wherein, when the processor is configured to cause the device to determine the at least one first instruction that is currently eligible for scheduling, the processor is configured to cause the device to:
determine at least one second instruction having no unscheduled predecessor instruction from the instruction sequence based on the relationship graph; and
select, from the at least one second instruction, the at least one first instruction whose scheduling moment matches the current moment.

12. The device according to claim 11, wherein, when the processor is configured to cause the device to select the at least one first instruction, the processor is configured to cause the device to:
acquire for each of the at least one second instruction, a predecessor instruction of the each of the at least one second instruction;
acquire, for the predecessor instruction, a scheduling moment of the predecessor instruction and a first duration, the first duration representing a duration from the scheduling moment of the predecessor instruction to a moment when an execution result of the predecessor instruction is transmitted to the each of the at least one second instruction;
determine a second moment based on the scheduling moment of the predecessor instruction and the first duration; and
designate the second instruction as the at least one first instruction when the second moment of the predecessor instruction does not exceed the current moment.

13. The device according to claim 10, wherein, when the processor is configured to cause the device to process the each of the at least one first instruction, the processor is configured to cause the device to:
acquire a target instruction that has not yet been scheduled and a third instruction that has been scheduled currently from the at least one first instruction;
detect resource occupation information of the target instruction and resource occupation information of the third instruction; and
determine that the target instruction can be scheduled at the current moment when the resource occupation information of the target instruction does not conflict with the resource occupation information of the third instruction; or determine that the target instruction cannot be scheduled at the current moment when the resource occupation information of the target instruction conflicts with the resource occupation information of the third instruction.

14. The device according to claim 13, wherein, when the processor is configured to cause the device to acquire the target instruction, the processor is configured to cause the device to perform at least one of the following:
selecting, from the at least one first instruction, a first instruction whose corresponding node has a maximum height in the relationship graph, and taking the first instruction as the target instruction;
selecting, from the at least one first instruction, a first instruction whose corresponding node has a maximum number of successor nodes in the relationship graph, and taking the first instruction as the target instruction;
selecting, from the at least one first instruction, a first instruction that occupies a maximum number of resources during execution, and taking the first instruction as the target instruction; or
selecting, from the at least one first instruction, the first L first instructions in the instruction sequence, and taking the first instructions as the target instructions, L being a positive integer.

15. The device according to claim 9, wherein, when the processor executes the computer instructions, the processor is configured to further cause the device to:
combine, for each instruction in the instruction sequence, the each instruction and a moment when the each instruction is successfully scheduled into a scheduling information pair corresponding to the each instruction; and
store the scheduling information pair in a scheduled set.

16. The device according to claim 15, wherein, when the processor executes the computer instructions, the processor is configured to further cause the device to:
acquire scheduling information pairs of the plurality of instructions, each scheduling information pair comprising an instruction and a corresponding scheduling moment at which the instruction is successfully scheduled; and
adjust the scheduling time sequence of the plurality of instructions in the parallel loop iterations based on the scheduling information pairs of the plurality of instructions, to minimize the target loop interval.

17. A non-transitory storage medium for storing computer readable instructions, the computer readable instructions, when executed by a processor, causing the processor to:
acquire an instruction sequence, and constructing a relationship graph of the instruction sequence, the instruction sequence comprising a plurality of instructions for loop execution, each of a plurality of nodes in the relationship graph representing a respective instruction in the instruction sequence, and an edge connecting two nodes in the relationship graph representing a dependency relationship between two instructions corresponding to the two nodes;
determine, based on the relationship graph, a loop interval representing a maximum time interval for a current loop within which the same instruction is scheduled in two adjacent loop iterations;
progressively reduce the loop interval and, upon failing to successfully schedule the plurality of instructions within the current loop for the first time, determine an interval of a previous loop as a target loop interval for the current loop; and
adjust a scheduling time sequence of the plurality of instructions in parallel loop iterations based on the target loop interval, and loading the adjusted instructions onto a chip for execution.

18. The non-transitory storage medium according to claim 17, wherein, when the computer readable instructions cause the processor to determine the loop interval based on the relationship graph, the computer readable instructions cause the processor to:
determine, from the instruction sequence and based on the relationship graph and a current moment, at least one first instruction that is currently eligible for scheduling, each of the first instruction having no unscheduled predecessor instruction, and the current moment matching a scheduling moment of the first instruction;
process each of the at least one first instruction, and determining whether each of the at least one first instruction can be scheduled successfully; and
determine the loop interval based on a next moment when it is determined that all instructions in the instruction sequence have been successfully scheduled at the current moment.

19. The non-transitory storage medium according to claim 18, wherein, when the computer readable instructions cause the processor to determine the at least one first instruction that is currently eligible for scheduling, the computer readable instructions cause the processor to:
determine at least one second instruction having no unscheduled predecessor instruction from the instruction sequence based on the relationship graph; and
select, from the at least one second instruction, the at least one first instruction whose scheduling moment matches the current moment.

20. The non-transitory storage medium according to claim 19, wherein, when the computer readable instructions cause the processor to select the at least one first instruction, the computer readable instructions cause the processor to:
acquire for each of the at least one second instruction, a predecessor instruction of the each of the at least one second instruction;
acquire, for the predecessor instruction, a scheduling moment of the predecessor instruction and a first duration, the first duration representing a duration from the scheduling moment of the predecessor instruction to a moment when an execution result of the predecessor instruction is transmitted to the each of the at least one second instruction;
determine a second moment based on the scheduling moment of the predecessor instruction and the first duration; and
designate the second instruction as the at least one first instruction when the second moment of the predecessor instruction does not exceed the current moment.
